(19) United States
(12) Patent Application Publication
(10) Pub. No.: US 2015/0093516 A1
(43) Pub. Date: Apr. 2, 2015

(54) METAL-FILM FORMING METHOD, METHOD FOR MANUFACTURING A METAL-FILM FORMED PRODUCT AND SYSTEM FOR MANUFACTURING THE SAME

(71) Applicants: Ibaraki Giken Limited, Ibaraki (JP); M&M Research Laboratory, Co., Ltd., Ibaraki (JP)

(72) Inventors: Shinji ARAGA, Kitaibaraki (JP); Nobuyuki MIYAGI, Kitaibaraki (JP); Mitsugu YAMAGUCHI, Kitaibaraki (JP); Kentaro NAKATA, Kitaibaraki (JP); Mamoru MITA, Hitachi (JP); Katsuhiro MAEKAWA, Hitachi (JP); Kazuhiko YAMASAKI, Hitachi (JP)

(21) Appl. No.: 14/497,484

(22) Filed: Sep. 26, 2014

(30) Foreign Application Priority Data
Sep. 27, 2013 (JP) 2013-202200

(51) Int. Cl. B05D 3/14; B05C 9/10; B05C 9/12; B05D 3/02

(52) U.S. Cl. CPC B05D 3/14; B05D 3/0263; B05C 9/10; B05C 9/12
USPC 427/542; 427/554; 118/37; 118/44

(57) ABSTRACT

A metal-film forming method of the present invention includes a surface activation process of irradiating a laser beam to the surface of the base metal, thereby activating the surface of the basemetal, a noble-metal nanoparticle dispersion liquid coating process of coating the surface of the base metal with a noble-metal nanoparticle dispersion liquid, a solvent thereof, containing noble-metal nanoparticles in as-dispersed state, and a noble-metal nanoparticle sintering process of irradiating the laser beam to the noble-metal nanoparticle dispersion liquid coated on the surface of the base metal, thereby causing the noble-metal nanoparticles to be sintered. Further, a scudding press process of executing press forming of a base metal, and the metal-film forming process of applying noble-metal plating to the surface of the base metal are executed on the same line.

### CLAIM OF PRIORITY

The present application claims priority from Japanese Patent application serial no. 2013-202200, filed on Sep. 27, 2013, the content of which is hereby incorporated by reference into this application.

### TECHNICAL FIELD

The present invention relates to a metal-film forming method, a method for manufacturing a metal-film formed product, and a system for manufacturing the same, and in particular, to a metal-film forming method suitable for use in forming an electrically conductive film on a contact used in an electronic-device including a connector, switch, memory card, lead frame, and MEMS (Micro Electro Mechanical System) sensor as well as a terminal material, a method for manufacturing a metal-film formed product, and a system for manufacturing the same.

### BACKGROUND ART

For an electric contact used in a mobile phone, smart phone, USB memory, SD card, etc., use is made of a terminal fitting that is formed by precision and micrometal press forming. In the manufacture of a terminal fitting for use in the electric contact, and so forth, press forming is executed with the use of a metal press forming machine before execution of partial electroplating with gold or silver. For the press forming, a high-speed crank press using a scudding stamping die is usually adopted. There has been a tendency that a high-speed servo press is used for a connector of which a complex and precision electric contact structure is required, whereas a forging press, etc. are used for a connector used in a high power device having a high current-current carrying capacity. The press forming and an electroplating working are normally carried out on individual lines isolated from each other due to a difference in line speed. For this reason, enhancement in productivity of the terminal fitting has its limitations. Further, since partial plating is executed in the electroplating working, use of a dedicated mask, and various processes including application of partial-plating resists, image development and peel-off of the plating resists are required, thereby rendering the electroplating working expensive. Furthermore, in a wet plating method, much use is made of chemicals causing environmental pollution, involving costs necessary for liquid waste disposal and drainage treatment, respectively, thereby rendering the wet plating method expensive.

In order to solve problems described as above, there is available a plating method described in Japanese Unexamined Patent Application Publication No. 2004-259674 (Patent Literature 1). In this Patent Literature 1, there is described a method whereby before fold-back working of a female terminal fitting composed of a copper alloy piece that is punched in metal press forming, an ink including electrically conductive particles (gold particles) is printed in part of a male terminal fitting, coming in contact with the female terminal fitting, by use of an ink jet printing method, thereby forming a plating layer at a desired thickness, and in desired size on the surface of a terminal fitting by irradiating a pulse laser beam to printing spots. In this case, a solvent is dried prior to irradiation to be thereby removed. In this Patent Literature 1, the female terminal fitting is manufactured by the fold-back working after the formation of the plating layer. Further, with Patent Literature 1, it is described that these ink jet printing apparatus and a pulse laser beam irradiation system are assembled into a conventional terminal-fitting production line where punching and fold-back working are executed, whereupon manufacturing of terminals is enabled by scudding.

Further, in Japanese Unexamined Patent Application Publication No. 2009-283783 (Patent Literature 2), there is disclosed a method whereby a metal nanoparticle dispersion liquid at a predetermined thickness of an applied liquid is applied onto a substrate whose surface is covered with a liquid-repellent agent coated layer, and a laser beam at a predetermined wave length is vertically irradiated from the surface of the liquid coated-layer, thereby selectively removing laser exposure regions of the liquid-repellent agent coated layer in contact with the liquid-repellent agent coated layer, whereupon the applied liquid-layer is continuously irradiated with the laser beam at the predetermined wave length to raise a temperature at the interface between the substrate and the applied liquid-layer, thereby forming a metal nanoparticle sintered film exhibiting high adherence on the surface of the substrate.

### CITATION LIST

### Patent Literature

[Patent Literature 1] Japanese Unexamined Patent Application Publication No. 2004-259674
[Patent Literature 2] Japanese Unexamined Patent Application Publication No. 2009-283783

### SUMMARY OF INVENTION

### Technical Problem

In Patent Literature 1, a copper alloy is used as a constituent material of the terminal fitting. Further, it is described in Patent Literature 1 that since the electrically conductive particle is a gold particle whose melt point is at 1064° C., substantially the same as the melt point of copper, that is, 1063° C., a gold plated layer can be fixed onto the surface of a copper base material. Furthermore, it is described in Patent Literature 1 that if tin plating is applied to a terminal fitting, the gold particle is not melted while only a tin plated layer is melted because the melt point of tin is as low as 232° C., so that the gold particle is fixed onto the surface of the tin plated layer as in the case of brazing.

With Patent Literature 1, however, since there is hardly a difference in melting point between the gold particle and the copper base material, it is difficult to form the gold plated layer without causing the base material to incur melting damages. Further, in order for gold to be heated up to its melting point, laser irradiation time will become longer. Accordingly, there is a possibility that the line speed of a process of forming the plated layer will be considerably less than the line speed of a process of the pressing, so that it is practically difficult to bring the process of forming the plated layer into the process of the metal scudding pressing. Further, in the case of a terminal fitting having a tin plated layer, a problem occurs in that gold particles are dispersed in the tin plated layer in as-melted state, so that a gold plating surface layer cannot be formed.

Further, in Patent Literature 2, use of a metal substrate, such as a copper substrate, a copper alloy substrate, etc., is indicated. Localized heating by use of laser irradiation is executed, whereupon high adhesion of an interface between the surface of the metal substrate and the metal nanoparticle sintered film can be obtained due to interd if fusion following a rise in temperature of the surface of the substrate. Copper and a copper alloy each are known as a metal susceptible to interdiffusion with a metal such as gold, silver, etc. Accordingly, the metal nanoparticle sintered film excellent in adherence can be obtained, however, if the metal nanoparticle sintered film has a thickness as small as 1 μm or less, ground copper atoms will be diffused up to the surface, thereby forming an alloy layer composed of copper and the metal nanoparticle sintered film on the surface

Accordingly, with a contact terminal, such as a connector, etc., it has lately become a general practice to provide a nickel plated layer as a barrier layer against diffusion of copper, on the surface of copper or a copper alloy, in order to prevent the lowering of electrical resistance, due to formation of the alloy layer. Furthermore, use of a stainless steel material lower in cost, such as SUS 304 in the Japanese Industrial Standard, etc., has lately been adopted in place of copper or a copper alloy. According to the results of studies carried out by the inventor, et al., it has been concluded that it is difficult to form a plated layer excellent in adherence with the use of the method described in Patent Literature 1 or Patent Literature 2 because a solid passivated film layer is provided on the surface of the nickel plated layer or the stainless steel material.

It is an object of the present invention to provide a metal-film forming method capable of forming a plated layer excellent in adherence at a low cost even in the case where plating with the use of a noble metal, such as gold, and so forth, is executed on a base metal susceptible to formation of an oxide film and a passivation film.

Further, another object of the present invention is to provide a method for manufacturing a metal-film formed product, capable of bringing a plating process into a press line for a terminal fitting, etc., including a scudding process, and a system for manufacturing the same.

### Solution to Problem

According to one aspect of the present invention, there is provided a metal-film forming method for applying noble-metal plating to the surface of a base metal. The metal-film forming method includes a surface activation process of irradiating a laser beam to the surface of the base metal, thereby activating the surface of the base metal, a noble-metal nanoparticle dispersion liquid coating process of coating the surface of the base metal with a noble-metal nanoparticle dispersion liquid, a solvent thereof, containing noble-metal nanoparticles in as-dispersed state, and a noble-metal nanoparticle sintering process of irradiating the laser beam to the noble-metal nanoparticle dispersion liquid coated on the surface of the base metal, thereby causing the noble-metal nanoparticles to be sintered.

According to another aspect of the present invention, there is provided a method as well as a system for manufacturing a metal-film formed product, including a scudding press process of executing press forming of a base metal, and a metal-film forming process of applying noble-metal plating to the surface of a base metal, the scudding press process and the metal-film forming process being executed on the same line. The metal-film forming process includes a cleaning process of removing oil attached to the surface of the base metal, a liquid-repellent agent coating process of coating the surface of the base metal after the cleaning process with a liquid-repellent agent, a surface activation process of irradiating a laser beam to a noble-metal plating applied region of the base metal after the liquid-repellent agent coating process to thereby execute surface activation, a noble-metal nanoparticle dispersion liquid coating process of noncontact-coating a region of the base metal after the surface activation process, the region being subjected to the surface activation, with a noble-metal nanoparticle dispersion liquid, a solvent thereof, containing noble-metal nanoparticles in as-dispersed state, a solvent-drying process of causing part of the solvent in the noble-metal nanoparticle dispersion liquid coated on the base metal after the noble-metal nanoparticle dispersion liquid coating process to be partially evaporated by use of a far infrared heater, and a noble-metal nanoparticle sintering process of irradiating the laser beam to the noble-metal nanoparticle dispersion liquid, part of the solvent thereof being evaporated, and the liquid being coated on the base metal after the solvent-drying process, thereby causing the noble-metal nanoparticles to be sintered.

Further, with the method as well as the system for manufacturing the metal-film formed product, a position identifier is preferably provided in the base metal, and the surface activation process, the noble-metal nanoparticle dispersion liquid coating process, and the noble-metal nanoparticle sintering process, included in the metal-film forming process, are executed, based on noncontact detection of the position identifier, such that a laser-beam irradiation region in the surface activation process, a noble-metal nanoparticle dispersion liquid coating region in the noble-metal nanoparticle dispersion liquid coating process, and a laser-beam irradiation region in the noble-metal nanoparticle sintering process are overlapped with each other.

### Advantageous Effects of Invention

With the present invention, it becomes possible to form a plated layer excellent in adherence at low cost even in the case of executing plating with a noble-metal, such as gold, etc., on a base metal that is susceptible to formation of an oxide film and a passivation film.

Further, with the present invention, it becomes possible to in-line a plating process into a press line for a terminal fitting, etc., including a scudding process.

Problems, configurations and effects, other than those described as above, will be apparent from the following detailed description of the preferred embodiments of the invention.

### BRIEF DESCRIPTION OF DRAWINGS

FIG. 1 is a view illustrating a system for manufacturing a metal-film formed product, according to an embodiment of the invention;

FIGS. 2A and 2B each are a view illustrating the shape of a terminal fitting for use as a press formed connector;

FIG. 3 is a view illustrating respective states of an oxide film before and after the activation on the surface of stainless SUS 304 coated with nickel electroplating, according to results of analysis by X-ray photoelectron spectroscopy;

FIG. 4 is a view for explaining a method for deciding the positioning of a metal strip (a base metal) by making use of a position identifier;

FIG. 5 is a view illustrating a system for manufacturing the metal-film formed product, according to another embodiment of the invention;

FIG. 6 is a view illustrating the shape of a metal strip with pilot holes formed therein;

FIG. 7 is a view illustrating the spectral emissivity of a far infrared heater used in the embodiment of the invention;

FIG. 8 is a view illustrating a spectral exitance curve of the far infrared heater used in the embodiment of the invention;

FIG. 9 is a view illustrating the infrared transmission spectra of a gold nanoparticle dispersion liquid used in the embodiment of the invention; and

FIGS. 10A and 10B each are a view illustrating the shape of a press formed terminal fitting with noble-metal plating applied thereto for use as a connector.

### DESCRIPTION OF EMBODIMENTS

Embodiments of the invention are described below with reference to the accompanied drawings.

First, the development to lead to the present invention is explained.

The present invention relates to a metal -film forming method for forming a noble-metal nanoparticle sintered film serving as the plating of a noble-metal, such as gold, silver, etc., used in an electric contact such as a terminal fitting, etc.

The noble-metal nanoparticle sintered film is a metal film excellent in adherence if the same is formed as described in Patent Literature 2. However, in the case where the noble-metal nanoparticle sintered film is formed on a base metal (substrate) of phosphor bronze, etc., with a stainless material or a nickel electroplating, applied on the surface thereof, it is difficult to form a noble-metal nanoparticle sintered film excellent in adherence owing to a passivation film (an oxide film), formed on the surface of the base metal.

More specifically, the stainless material contains nickel, and chromium, and the passivation film mainly composed of oxides of these elements is formed on the surface. The stainless material is improved in corrosion resistance due to the formation of the passivation film, however, it is difficult to form a noble metal plated film excellent in adherence on the stainless material even by use of wet electroplating. A stainless passivation film has a thickness normally in a range of 1 to 10 nm. Because this passivation film is very dense and stable, the passivation film exhibits high corrosion resistance. The passivation film is rapidly dissolved in an acidic aqueous solution containing halogen such as hydrochloric acid and so forth to be removed. However, in a process for forming a noble-metal nanoparticle sintered film, it is desirous to remove the passivation film in a dry process without using those chemicals. Furthermore, in the case of introducing a process for forming the noble-metal nanoparticle sintered film for use in an electric contact (a noble-metal plating process) into a high-speed press line using a scudding stamping die at, for example, in a range of 100 to 1000 spm {spm: the number of press shots per one minute (the number of workings such as stamping, bending, forging, etc., performed by dropping a press punch)}, the passivation film must be removed within a time length not more than 0.06 seconds, however, no method for realizing the removal of the passivation film in such a way as described has thus far been conceived.

Further, with a nickel plated film formed on phosphor bronze, etc., by use of electroplating, etc., an oxide film (a nickel oxide film) is formed on the surface, as with the case of stainless, so that it is difficult to form the noble-metal nanoparticle sintered film excellent in adherence. In the case of applying noble-metal electroplating to the nickel plated film, there is executed nickel electroplating undercoating, using a plating bath popularly called as a special Wood's nickel bath (hydrochloric acid bath) capable of dissolving a nickel oxide film on the surface for removal. This Wood's nickel undercoat is also popularly called as a strike nickel plating, having a high bath-voltage, thereby enabling an extremely thin nickel electroplating high in anchor effect (anchoring effect), normally on the order of 0.1 μm. If a silver or gold plating solution, containing a cyanogen compound, is used on the surface of this extremely thin strike nickel plating film, this will enable noble-metal electroplating to be performed without causing a nickel surface to be oxidized. However, if such an electroplating as described is adopted, it is difficult to achieve reduction in cost, leading to use of chemicals deleterious to human bodies, such as the cyanogen compound, etc., as well as chemical substances causing environment pollution. Furthermore, it is impossible to introduce such electroplating as described into the high-speed press line using the scudding stamping dies at, for example, in the range of 100 to 1000 spm.

If the passivation film (the oxide film) formed on a stainless surface as well as a nickel electroplating surface can be removed by use of the dry process, this will enable the noble-metal nanoparticle sintered film excellent in adherence to be formed. Further, if the passivation film (the oxide film) can be removed at a high speed, this will raise a possibility that a process for forming the noble-metal nanoparticle sintered film (a noble-metal plating process) can be introduced into the high-speed press line at, for example, in the range of 100 to 1000 spm.

As a result of various studies, the inventor, et al. have found out that the passivation film (the oxide film) can be removed within the shortest time length of not more than 0.01 sec, by irradiation of a base metal (a substrate), such as stainless, a nickel electroplating film, etc., with a laser beam under atmospheric conditions although this is dependent on magnitude of a working range (an area).

In other words, the inventor, et al. have found out that the passivation film (the oxide film) can be instantly removed within the shortest time length of not more than 0.01 sec by application of a laser marking method to a metal. This means that conditions required of the processing time length (not more than 0.06 sec) are satisfied in the case of introducing the process for forming the noble-metal nanoparticle sintered film for use in an electric contact (the noble-metal plating process) into the high-speed press line using the scudding stamping die at, for example, in the range of 100 to 1000 spm.

For laser color marking to a metal, use is made of the fundamental harmonic (1064 nm) of YAG laser and the second, third, fourth harmonic components thereof. In the laser color marking, a metal surface is radiated with a laser beam at a specific wavelength in the atmosphere, and an oxide film and a nitride film are partially formed only at laser beam radiated portions of the metal surface, respectively, thereby effecting marking by taking advantage of interference colors generated according to thicknesses of the oxide film and the nitride film, respectively. This technique is also called as laser coloring, or the laser color marking and so forth because the interference color undergoes a change in color owing to selection of respective thicknesses of the oxide film and the nitride film.

Further, the inventor, et al. have found out that if a metal surface is irradiated with such laser beams as adjusted in respect of wavelength, frequency, and output, respectively, in the atmosphere, not only the passivation film (the oxide film) on the metal surface can be removed but also the oxide film and the nitride film are not allowed to occur even in the atmosphere.

In the case where a metal nanoparticle dispersion liquid (usually called a metal nanoparticle ink, an electrically conductive paste of metal nanoparticles, etc.) is applied to a metal surface to thereby execute laser sintering of metal nanoparticles, a technique is adopted whereby a liquid-repellent agent is applied to the surface of a metal in advance as described in Patent Literature 2 in order to prevent scattering of a discharge ink (the metal nanoparticle dispersion liquid) and spreading of the discharge ink on the surface, due to the ink jet printing or the like, thereby enabling execution of pattern printing in a stable shape. In order to obtain a metal nanoparticle sintered film excellent in adherence with a substrate, there is the need for removing the liquid-repellent agent concurrently with the passivation film. The inventor, et al. have also found out that the liquid-repellent agent on the surface, and the passivation film on a stainless surface as well as a nickel plating surface can be concurrently removed by one laser-beam irradiation through condition adjustment.

With the present invention, while the liquid-repellent agent, and the passivation film on the surface are concurrently removed by laser-beam irradiation, a newly-formed surface is instantly formed on the surface of a metal without forming a new passivation film even in the atmosphere, and a highly adherent noble-metal nanoparticle sintered film (laser sintered film) is formed on the newly-formed surface. In other words, with the present invention, it is intended that a base metal undergoes surface activation by the laser-beam irradiation before being coated with a noble-metal nanoparticle dispersion liquid such that a noble-metal nanoparticle sintered film that is highly adherent can be formed.

With the present invention, as a result of removal of the passivation film by virtue of a simple dry process called the laser beam irradiation, the noble-metal nanoparticle sintered film that is highly adherent can be formed on a base metal such as phosphor bronze, etc., coated with stainless and nickel plating.

Further, in the case of in-lining a noble-metal plated film forming process to a high-speed press line at, for example, in the range of 100 to 1000 spm, there is the necessity of carrying out sintering of noble-metal nanoparticles at one point in a range of 0.6 to 0.06 sec, however, the high-speed press line in combination with a noncontact noble-metal nanoparticle dispersion liquid printing, etc., as a selective noble-metal partial-plated film forming process for an electric contact point such as a terminal fitting, etc., can be introduced into a press forming line for the terminal fitting, etc. Since a press forming process is integrated with a noble-metal nanoparticle sintered film forming process, a manufacturing cost with respect to the terminal fitting, etc. can be largely reduced.

Now, the metal-film forming method (a noble-metal plating method) according to the invention has the following advantageous effects as compared with the wet electroplating. More specifically, it is possible to realize a manufacturing method that is safe and effective for conservation of the terrestrial environment because neither chemicals deleterious to human bodies nor chemical substances leading to environment pollution are used in this method. Further, with this method, the process can be simplified, and it is possible to eliminate the need for facilities necessary for liquid waste disposal and drainage treatment, required in the case of the wet electroplating. Accordingly, the method is excellent in energy conservation measures from this point of view, and is capable of attaining substantial reduction in CO₂ emissions, thereby contributing to prevention of global warming. Further, in the case of wet partial electroplating, partial plating is executed with the use of a plating mask and a resist film, however, it is difficult to carry out plating of micro parts on the order of, for example, from φ 0.1 mm to φ 0.5 mm in diameter due to the osmosis of a plating liquid from the plating mask, the exfoliation of a partial plating resist, caused by immersion of a plating liquid, and so forth. With the present invention, the plating of micro parts on the order of from φ 0.1 mm to φ 0.5 mm in diameter can be realized with ease by application of precision micro printing using a noble-metal nanoparticle dispersion liquid. Furthermore, with the present invention, it becomes possible to reduce usage (a coating weight) of noble metal to 1/10 or less as compared with that in the case of the partial plating according to a mechanical masking method in the wet electroplating.

Next, there are broadly described below respective embodiments of a method for manufacturing a metal-film formed product, and a system for manufacturing the same, according to the invention, with reference to the accompanied drawings.

With the embodiments of the invention, describe below, a laser-beam irradiation process for metal surface activation, a noble-metal nanoparticle dispersion liquid coating process, and a process for causing a solvent of the noble-metal nanoparticle dispersion liquid to undergo high-speed drying are sequentially provided in a high-speed press forming working line, and thereafter, a process for successively irradiating the noble-metal nanoparticle dispersion liquid with a laser-beam is provided, thereby forming a metal film high in adherence on the surface of a metal press formed workpiece.

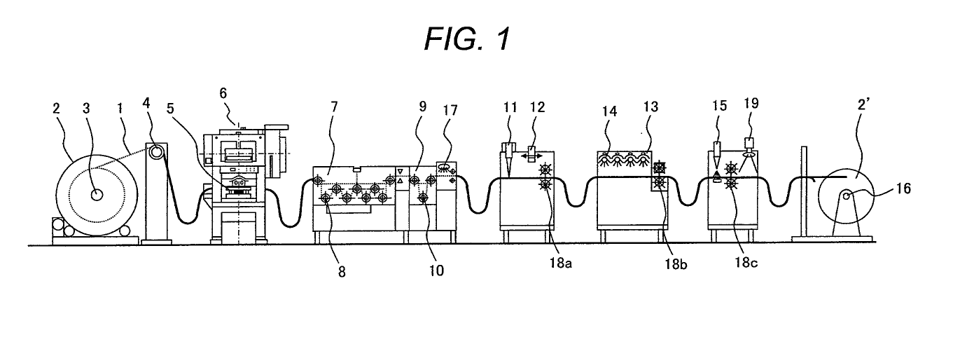

FIG. 1 shows a system for manufacturing a metal-film formed product, according to the embodiment of the invention. The system for manufacturing the metal-film formed product is made up such that a scudding press process for press forming on a base metal, and a metal-film forming process for applying noble-metal plating onto the surface of the base metal are executed on the same line, the system being provided with a let-off reel stand 3 serving as a metal strip feeder for supplying a base metal as a metal strip 1, a high-speed press machine 6 serving as a press device for executing the scudding press process, a cleaning tank 7 for removing oil attached to the surface of the base metal in the press process, a liquid-repellent treatment tank 9 for coating the surface of the base metal with a liquid-repellent agent, a surface-activation laser-beam irradiation unit 11 for irradiating a laser beam for surface-activation to a region of the base metal, for noble-metal plating, a noble-metal nanoparticle dispersion liquid coating unit 12 for noncontact-coating of a surface activated region of the base metal with a noble-metal nanoparticle dispersion liquid, a solvent thereof, containing noble-metal nanoparticles in as-dispersed state, an infrared drying furnace 13 provided with a plurality of far infrared heaters 14 for causing evaporation of part of the solvent in the noble-metal nanoparticle dispersion liquid applied to the base metal, a sintering laser-beam irradiation unit 15 for irradiating the laser-beam to the noble-metal nanoparticle dispersion liquid, part of the solvent thereof having undergone evaporation, thereby causing the noble-metal nanoparticles to be sintered, and a take-up reel stand 16 serving as a winding unit for winding up the metal strip.

A reel 2 wound up with the metal strip 1 on the order of 100 to 500 m in length is bridged over the let-off reel stand 3. The metal strip 1 for application to, for example, a connector is phosphor bronze, or a stainless (SUS 304, etc.), coated with nickel electroplating on the order of 0.8 to 1.5 μm in thickness. The metal strip 1 has a thickness in a range of about 0.1 to 0.5 mm, the thickness thereof being chosen according to the type of the connector. The metal strip 1 is slit to a width on the order of 10 to 100 mm so as to match the width of a scudding stamping die 5 of the high-speed press machine 6

The metal strip 1 is continuously delivered to the scudding stamping die 5 mounted in the high-speed press machine 6 from the let-off reel stand 3 via a guide roll 4. A press forming process for the terminal fitting, using the scudding stamping die 5, at on the order of 100 to 1000 spm, is executed by the high-speed press machine 6.

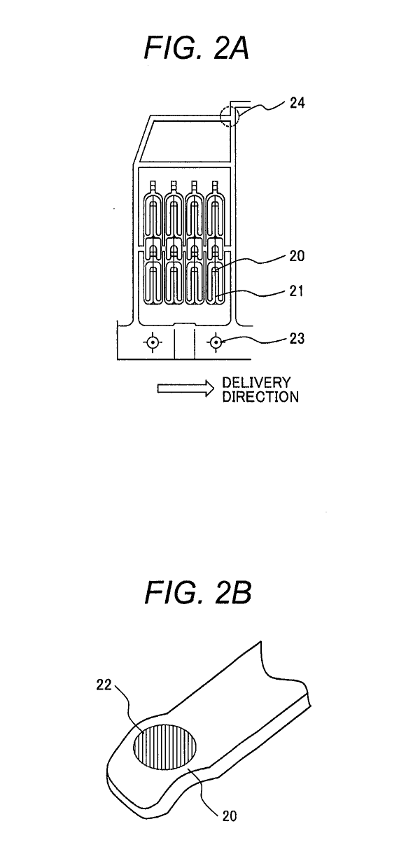

The shape of a terminal fitting for use as a press formed connector is shown by way of example in FIGS. 2A and 2B. The terminal fitting includes an insertion terminal fitting (a male terminal), and a receptacle terminal fitting (a female terminal). FIGS. 2A and 2B each show an example of the insertion terminal fitting. The insertion terminal fitting is composed of an electrical contact point 20 and an external connection terminal 21, and the electrical contact point 20 has a plating area 22 where a noble-metal partial plating process is applied to a portion of the electrical contact point 20, coming in contact with the female terminal. For noble-metal plating, use is made of silverplating, palladiumplating, goldplating, and so forth, however, much use is made of the gold plating owing to cost, and stability in contact resistance. As the main constituent material of the terminal fitting for use in a connector, much use is made of phosphor bronze high in spring characteristics, however, use is lately made of stainless steel as well for the purpose of reduction in cost. For the noble-metal plating on these main constituent material, nickel electroplating undercoating is first applied, and the noble-metal plating is applied thereon in the case of phosphor bronze. In the nickel electroplating undercoating, it is intended to prevent solid phase diffusion of copper contained in phosphor bronze from occurring on the surface of the noble-metal plating.

In a press process, a pilot hole 23 (position identifier) for use at the time for drive-control of delivery devices 18a, 18c provided in respective units described below is formed such that a laser-beam irradiation region in the surface-activation laser-beam irradiation unit 11, a noble-metal nanoparticle dispersion liquid coating region in the noble-metal nanoparticle dispersion liquid coating unit 12, and a laser-beam irradiation region in the sintering laser-beam irradiation unit 15 are overlapped with each other. The drive-control of the delivery devices using the position identifier will be described later on.

The metal strip 1 that has already been subjected to press forming, such as stamping, bending, deep drawing, forging, etc., executed in the high-speed press machine 6, is guided into the cleaning tank 7. The cleaning tank 7 is around 2 m in length and is provided with a plurality of guide rolls 8 to enable the metal strip 1 to vertically snake through therein in order to lengthen an immersion length of the metal strip 1. An oil for the press forming is cleansed inside the cleaning tank 7. For cleansing of the oil for the press forming, use is made of, for example, a hydrocarbon-based solvent. Cleaning time is dependent on the length of the cleaning tank 7 (in the case of snaking, such an immersion length as increased due to the snaking of the metal strip 1) and a processing speed (or a transfer speed) in the high-speed press machine 6. In order to shorten the cleaning time, ultrasonic cleaning may be used in combination.

The metal strip 1 after completion of cleaning is guided into the liquid-repellent treatment tank 9. The metal strip 1 passes along a guide roll 10 in the liquid-repellent treatment tank 9 to be immersed in a liquid-repellent agent, whereupon a liquid-repellent treatment is applied to a terminal fitting in whole. For the liquid-repellent agent, use is made of a commercially available fluorine-based or silicon-based agent. Liquid-repellent treatment time permitting the liquid-repellent agent to wet the surface of the terminal fitting to be spread thereon is sufficient for use, and a liquid-repellent treatment is completed in short time on the order of 10 sec.

The metal strip 1 after completion of the liquid-repellent treatment is guided into the surface-activation laser-beam irradiation unit 11 after the liquid-repellent agent is dried by use of a hot wire heater 17. In the surface-activation laser-beam irradiation unit 11, the metal strip as the base metal is spot-irradiated with a laser beam having a wavelength in a range of 500 to 550 nm. A liquid-repellent treatment layer and a passivation film (an oxide film), on the surface of a terminal fitting, are concurrently removed by this laser-beam irradiation, whereupon surface activation is executed. The laser beam has a beam diameter equivalent in size and shape to the plated area 22 (noble-metal plating applied part) of the electrical contact point 20, being in a range of, for example, on the order of φ 0.1 to φ 0.5 mm. For the laser beam with the wavelength in the range of 500 to 550 nm, use can be made of the harmonics of YAG laser and YVO₄ laser, respectively, with a wavelength of, for example, 1064 nm. A laser beam output is in a range of 0.1 to 2 W to be chosen so as to match the type as well as the thickness of the constituent material of the terminal fitting and a press forming shape. Further, the laser beam preferably has a frequency in a range of 10 to 100 kHz, and a pulse width in a range of 10 to 100 μs. As a result of selecting this condition, the liquid-repellent treatment layer and the oxide film on the surface of phosphor bronze, coated with nickel electroplating, are concurrently removed. Further, in the case of the stainless material, the liquid-repellent treatment layer and the passivation film are concurrently removed. If a laser output is increased more than necessary, this will cause a metal oxide film, and the base metal underneath the passivation film to be melted, and therefore, only metal oxide and the passivation film are preferably decomposed to be removed. The reason for this is because if the laser output is increased more than necessary and the metal of a laser irradiation part undergoes melting and evaporation, thereby turning the laser irradiation part into a concave, the performance of the terminal fitting for use as the electric contact will be adversely affected. More specifically, a problem occurs in that a contact area of the electric contact will be reduced, and the electrical resistance of a contact part will increase. Laser irradiation time is in a range of about 0.05 to 0.1 sec to be chosen according to a high-speed scudding press processing speed in the range of 100 to 1000 spm. In the case of laser beam irradiation of a region in a range of φ 0.1 to φ 0.5 mm, in diameter, instead of using a laser beam in diameter equivalent thereto, laser scanning may be made by use of a galvano mirror with a laser beam diameter, for example, on the order of φ 25 μm at intervals of 10 μm pitch.

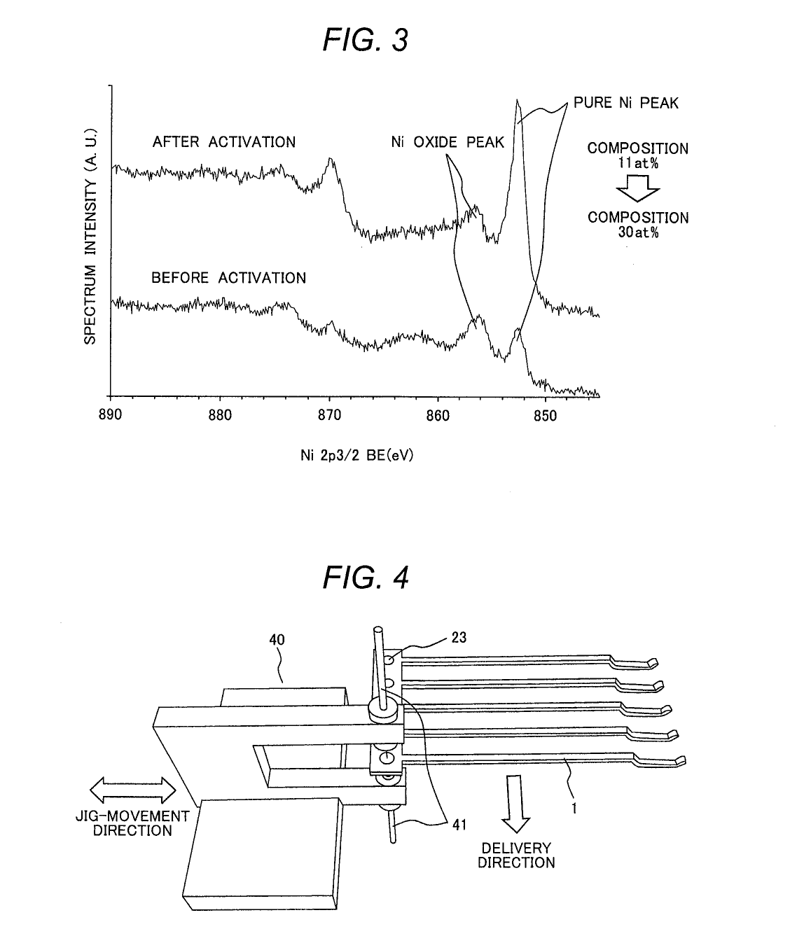

Effect of activation by use of the laser beam irradiation according to the invention is described below with reference to FIG. 3. FIG. 3 shows respective states of an oxide film before and after the activation on the surface of stainless SUS 304 coated with nickel electroplating, according to results of analysis by X-ray photoelectron spectroscopy (XPS).

A metal strip (a base metal) is stainless 304 coated with nickel electroplating in thickness ranging from 0.8 to 1.5 μm. The metal strip (the base metal) is 0.50 mm in thickness. A laser beam with a wavelength of 532 nm was irradiated thereto after application of the liquid-repellent treatment. For the laser beam with the wavelength of 532 nm, use was made of the second harmonic of YVO₄ laser with the wavelength of 1064 nm. With the laser beam, an output was set to 0.54 W, a repetitive frequency to 40 kHz, and a pulse width to 25 μs. A region of φ 0.8 mm was scanned by a laser beam φ 25 μm in diameter at intervals of 30 μm pitch, using the galvanomirror, to be followed by laser irradiation, and the surface activation of the metal strip was executed. Irradiation time of the laser beam was set to 0.048 sec.

A chemical bonding state on the surfaces of nickel electroplating before and after activation, respectively, was analyzed by X-ray photoelectron spectroscopy using a photoelectron spectrograph (JPS-9010TR) manufactured by JEOL Ltd. The analysis was carried out by focusing attention on Ni 2_{p 3/2} spectrum.

FIG. 3 shows Ni 2_{p 3/2} spectrum on the respective surfaces of nickel electroplating before and after the activation. In FIG. 3, the vertical axis indicates Ni 2_{p 3/2} spectrum intensity in an optional unit, and the horizontal axis indicates Ni 2_{p 3/2} bonding energy (eV). Further, a spectral distribution on the lower side indicates a spectral distribution before the activation, while a spectral distribution on the upper side indicates a spectral distribution after the activation. As shown in FIG. 3, a peak is obtained at 852.4 eV, and 856.5 eV, respectively, on the surface of nickel electroplating applied to stainless SUS 304, the peaks each representing bond energy of a nickel metal, and bond energy of a nickel oxide. There is a tendency that the peak of the nickel oxide is decreased after the activation, while the peak of nickel metal is increased. Further, as for XPS spectral peak-area ratios of oxygen and nickel, respectively, on the surfaces of nickel electroplating applied to stainless SUS 304, before and after the activation, respectively, it was found that oxygen (O) underwent a change from 89 to 70 at %, while nickel (Ni) from 11 to 30 at %. Accordingly, it is apparent that the oxide film on the surface of nickel electroplating applied to stainless SUS 304 was removed owing to the activation, thereby having increased a proportion of the nickel metal. In other words, if the surface of the metal strip (the base metal) is irradiated with the laser beam having the wavelength of 532 nm, the oxide film on the surface of the metal strip (the base metal) can be removed, and activation can be effected. In this connection, it is presumed that the oxide film is removed through the agency of ablation due to the laser-beam irradiation.

With the present invention, only the passivation film (the oxide film) on a metal surface is removed by irradiation of the surface of a base metal with a laser beam whose wavelength, frequency, and output are each adjusted, however, the respective conditions of the wavelength, frequency, and output can be determined as appropriate by checking the state of the metal surface by use of X-ray photoelectron spectroscopy after conducting experiments beforehand as to those conditions by referring to the respective ranges described as above.

Laser-beam irradiation is executed after deciding positioning on the basis of the pilot hole 23 (position identifier) formed in a terminal fitting, for use as a reference. A method for deciding the positioning of the metal strip (the base metal) is described below with reference to FIG. 4.

The surface-activation laser-beam irradiation unit 11 is provided with a noncontact type position-detecting device 40 for detecting the position of the position identifier. For the position-detecting device 40, use is made of a lighting/photo-sensing type small-spot fiber sensor 41. The position of the small-spot fiber sensor 41 is movable in a direction intersecting a delivery direction of the metal strip by use of a jig such that the position of the small-spot fiber sensor 41 is aligned with the passing position of the pilot hole 23 (the position identifier). A light-blocking state is detected by the small-spot fiber sensor 41, and a position of the metal strip, in the delivery direction, can be identified (the metal strip can be stopped at a predetermined position). Accordingly, if a laser beam irradiation position (the position in the delivery direction) is fixed, a predetermined position of the metal strip (the position of the plated area 22 of the electrical contact point 20) can be irradiated with the laser beam on the basis of the position identifier as the reference. If such a method as described above is adopted, the laser beam irradiation can be executed with accuracy on the order of ±15 μm on the basis of the pilot hole as the reference. Further, there can be the case where a pilot hole for other applications, differing in pitch from a product pitch, is present, and the case where other through-holes differing in shape are present on the same line as the pilot hole is positioned, so that detection at the product pitch on the basis of the pilot hole as the reference is not possible. In such cases, a position identifier can be set on the basis of a product shape. For example, a location at reference sign 24 in FIG. 2A can be used for the position identifier. In this case, the position of the small-spot fiber sensor 41 is moved to the location at the reference sign 24 by use of a jig.

Still further, if, for example, a fixed pin (a mechanical pilot pin) is inserted into the pilot hole 23, this will enable positioning of the metal strip 1 to be realized at a given position all the time. In general, however, in the case of positioning executed by insertion of the mechanical pilot pin, there will be limitations to a processing speed, and therefore, positioning (product stoppage) is preferably executed upon sensing made by the position identifier.

The metal strip 1 with the plated area thereof, already activated, is transferred to the noble-metal nanoparticle dispersion liquid coating unit 12. In the noble-metal nanoparticle dispersion liquid coating unit 12, the noble-metal nanoparticle dispersion liquid is applied to such a portion of the surface of the metal strip 1, as activated due to the laser beam irradiation. The noble-metal nanoparticle dispersion liquid is described in detail in Patent Literature 2, omitting therefore detailed description thereof herein. The noble-metal nanoparticle dispersion liquid is also called as an electrically conductive paste of noble-metal nanoparticles or a noble-metal nanoparticle ink. As the noble-metal nanoparticle dispersion liquid, use is made of a gold nanoparticle dispersion liquid, a silver nanoparticle dispersion liquid, a palladium nanoparticle dispersion liquid, etc. For coating with the noble-metal nanoparticle dispersion liquid, use can be made of a noncontact coating system such as an ink-j et printer, a high-speed dispenser, etc. The coating with the noble-metal nanoparticle dispersion liquid is executed after decision on the positioning is made on the basis of the pilot hole as the reference just as is the case with the decision on the laser beam irradiation position for the activation in the front-end process. By fixing the position of an jet-ink head or a dispenser nozzle, the noble-metal nanoparticle dispersion liquid can be applied with position accuracy of the terminal fitting, on the order of ±15 μm on the basis of the pilot hole as the reference. The coating amount of the noble-metal nanoparticle dispersion liquid is an amount to enable a sufficient thickness of a sintered film after the laser sintering to be acquired. It is possible to achieve coating time of one point (a scope of one region serving as the electric contact of a terminal fitting) falling within a range of 0.05 to 0.1 sec by use of a noncontact coating system such as a high-speed ink-jet printer, a high-speed discharge type dispenser, etc. Furthermore, since the liquid-repellent agent remains on the outer periphery of the surface, other than the portion of the surface, subjected to the activation by the agency of the laser beam irradiation, it is possible to obtain the effect of preventing the liquid-repellent agent from wetting a region other than the region subjected to the activation by the agency of the laser beam irradiation to be spread thereon, so that printing accuracy is basically dependent on the position of the activation by the laser beam irradiation. More specifically, if a region ranging from φ 0.1 mm to φ 0.5 mm is activated in the surface-activation laser-beam irradiation unit 11, this will enable high precision and micro printing to be realized.

With the system for manufacturing the metal-film formed product, shown in FIG. 1, the surface-activation laser-beam irradiation unit 11 and the noble-metal nanoparticle dispersion liquid coating unit 12 are provided in the same case. As the surface-activation laser-beam irradiation unit 11 and the noble-metal nanoparticle dispersion liquid coating unit 12 are disposed in close proximity to each other in the same chamber, disappearance in the effect of surface-activation can be checked. In this case, the delivery device 18a serves as a delivery device shared by the surface-activation laser-beam irradiation unit 11 and the noble-metal nanoparticle dispersion liquid coating unit 12.

The metal strip 1 coated with the noble-metal nanoparticle dispersion liquid is guided into the infrared drying furnace 13 provided with the plural far infrared heaters 14. A delivery speed of the metal strip 1 in the infrared drying furnace 13 is adjusted by a delivery device 18b. A portion of the solvent of the noble-metal nanoparticle dispersion liquid as applied is dried in the infrared drying furnace 13. In this drying process, it is not intended to completely remove the solvent of the noble-metal nanoparticle dispersion liquid. The metal nanoparticle dispersion liquid normally includes the solvent in a range of 85 to 90% by volume. Accordingly, a noble-metal nanoparticle sintered film after completely sintered has a thickness corresponding to 10 to 15% of the thickness of the noble-metal nanoparticle dispersion liquid as applied. In this drying process, drying is executed such that a residual solvent volume will be on the order of 50% by volume (the noble-metal nanoparticles being substantially equivalent in volume to the solvent). If such a preliminary drying process as described above is carried out, this will enable a sintered film having no pore or the like in the noble-metal nanoparticle film after the laser sintering to be obtained. In this dry process, drying can be executed in an electric furnace as well, however, it is preferable to use the infrared drying furnace in the case of introducing the dry process into the press forming process line.

In the infrareddrying furnace, use is made of far infrared rays with a wavelength in a range of 3 to 5 μm. If a tunnel drying furnace using the far infrared rays is formed, and the metal strip 1 is caused to pass therethrough, drying with little variation can be executed. If a surface temperature of the far infrared heater is set to a range of 300 to 500° C., and passing time (heating time) of the tunnel drying furnace is set to a range of around 20 sec to 1 min, this will enable preliminary drying process as intended to be achieved. The temperature of a noble-metal nanoparticle dispersion liquid coated-surface will never reach a temperature in the range of 300 to 500° C. because the latent heat of evaporation, necessary for causing dissipation of the solvent, will be taken away from the temperature of the noble-metal nanoparticle dispersion liquid coated-surface. Accordingly, the sintering of the noble-metal nanoparticles is not started in this preliminary drying process. For the solvent of the noble-metal nanoparticle dispersion liquid, use is made of tetradecane (C₁₄H₃₀) having a boiling point at 253° C., and so forth. Since the latent heat of evaporation is taken away from the coated portion of the noble-metal nanoparticle dispersion liquid, the coated portion is kept at a temperature not higher than the boiling point of the solvent. Further, because the surface of the noble-metal nanoparticle is covered with a compound (a dispersant), such as alkylamine,. etc., the sintering is not started in this preliminary drying process, and the coated portion is stably maintained.

The metal strip 1 coated with the noble-metal nanoparticle dispersion liquid, to be subjected to the preliminary drying process, is guided into the sintering laser-beam irradiation unit 15. In the sintering laser-beam irradiation unit 15, a sintering laser beam is irradiated in order to cause sintering of the noble-metal nanoparticles in the noble-metal nanoparticle dispersion liquid, subjected to the preliminary drying process. For the sintering laser beam, use can be made of a YAG laser having the standing wave with a wavelength of 1064 nm, and an LD laser, etc. The sintering of the noble-metal nanoparticles, such as gold and silver nanoparticles, with the use of the laser beam at this wavelength, can be completed in a short time in a range of 0.01 to 0.05 sec if irradiation is executed at a laser output corresponding to the quality as well as the shape of a terminal fitting. Accordingly, synchronization in speed with the high-speed scudding press forming process can be achieved.

Further, in the case of spot irradiation with the sintering laser beam, the spot irradiation is executed by deciding the positioning on the basis of the pilot hole as the reference just as is the case with the laser beam irradiation position for the activation, and the coating position of the noble-metal nanoparticle dispersion liquid. By so doing, the laser-beam irradiation region in the surface-activation laser-beam irradiation unit 11, the noble-metal nanoparticle dispersion liquid coating region in the noble-metal nanoparticle dispersion liquid coating unit 12, and the laser-beam irradiation region in the sintering laser-beam irradiation unit 15 are overlapped with each other, whereupon a high-precision and micronoble-metalplating film can be formed at an electrical contact point.

With the present embodiment, an inspection unit 19 using an image sensor is provided behind the sintering laser-beam irradiation unit 15 so as to enable an inspection on whether or not a noble-metal plating film is correctly formed on the electrical contact point of each terminal fitting.

The metal strip 1 having passed through the laser-sintering process is guided to the take-up reel stand 16 to be wound up by a dedicated reel 2′. By so doing, both the press forming process, and formation of the noble-metal nanoparticle sintered film on the terminal fitting are completed.

With the system for manufacturing the metal-film formed product, according to the present embodiment, since the metal strip 1 with the press forming process applied thereto remains as a long object after the press process, the metal strip 1 can be transported by the agency of tension on the take-up reel side of the take-up reel stand 16, or transport rolls disposed at respective locations (the delivery devices 18a to 18c, etc.). Transport speeds of the respective processes are under control by driving of a sequence-controlled motor in such a way as to prevent a press formed workpiece from being deformed due to slackness and high tension.

With the system for manufacturing the metal-film formed product, as shown in FIG. 1, a method for forming the noble-metal nanoparticle sintered film after the press forming process (prior-press forming process method) is adopted. The present invention, however, is also applicable to the case where the noble-metal nanoparticle sintered film is formed prior to the press forming process, and subsequently, the terminal fitting is manufactured by the press forming process (post-press forming process method).

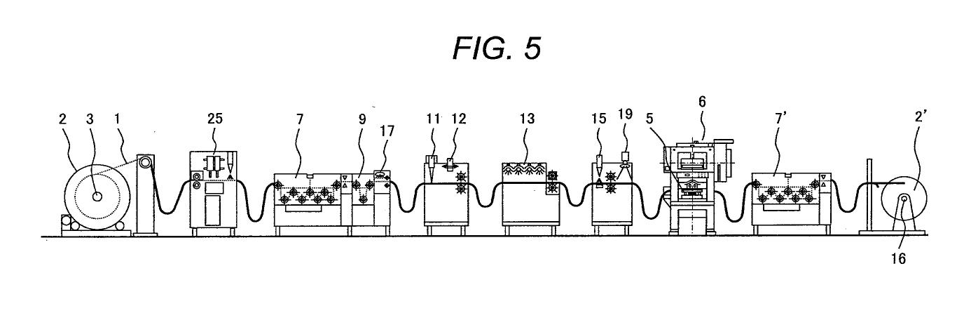

FIG. 5 shows an embodiment of the system for manufacturing the metal-film formed product, using the post press forming process, according to the invention. Detailed description of units identical in function to the respective units of the system for manufacturing the metal-film formed product, shown in FIG. 1, is omitted.

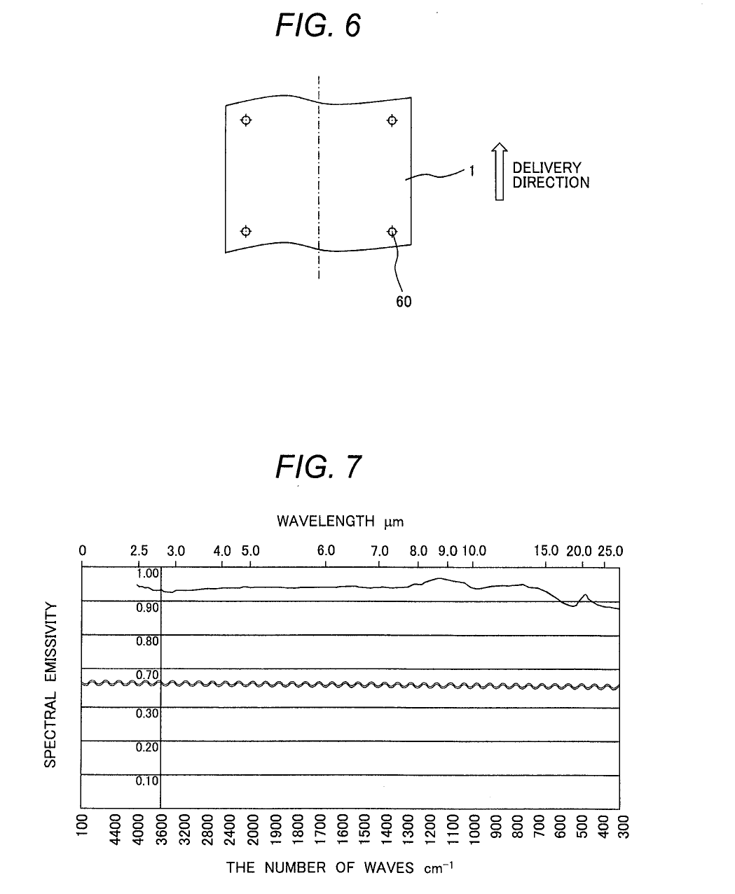

The system, shown in FIG. 5, is provided with a small-type press machine 25 with a blanking die mounted therein. In the small-type press machine 25 with the blanking die mounted therein, respective pilot holes (respective position identifiers) for use in positioning of the laser-beam irradiation region in the surface-activation laser-beam irradiation unit 11, the noble-metal nanoparticle dispersion liquid coating region in the noble-metal nanoparticle dispersion liquid coating unit 12, the laser-beam irradiation region in the sintering laser-beam irradiation unit 15, and a press forming process position in the high-speed press machine 6. FIG. 6 shows a metal strip 1 with the respective pilot holes 60 formed therein.

Thereafter, the metal strip 1 is guided into the cleaning tank 7 in order to cleanse a press oil for use in working on the respective pilot holes. Thereafter, respective processes up to the high-speed press machine 6 are identical to those shown in FIG. 1. Thereafter, the respective processes are executed so as to be synchronized in speed with a high-speed scudding press process that follows up.

The metal strip 1 after completion of the laser sintering in the sintering laser-beam irradiation unit 15 is guided into the high-speed press machine 6 with the scudding press die mounted therein, whereupon the press forming process for a terminal fitting is executed. The press forming process is executed on the basis of the respective pilot holes formed in the small-type press machine 25, as the reference. After the press forming process, final cleaning is executed through a hydrocarbon-based cleaning tank 7′. Then, the metal strip 1 is finally guided to the take-up reel stand 16 to be wound up by the dedicated reel 2′. By so doing, the press forming process, and the formation of the noble-metal nanoparticle sintered film on the terminal fitting are completed.

Subsequently, there are described examples of a manufacturing method executed by use of the system for manufacturing the metal-film formed product.

### EXAMPLE 1

The present example represents the prior-press forming process method, which was executed by use of the system for manufacturing the metal-film formed product, shown in FIG. 1.

Use was made of the reel 2 wound up with a metal strip 1, 100 m in length. The metal strip was for application to a connector, being phosphor bronze coated with nickel electroplating in a range of 0.8 to 1.5 μm in thickness. The metal strip was 0.12 mm in thickness. The metal strip 1 was slit to a width of 37.7 mm so as to match the width of a scudding stamping die 5.

Use was made of the cleaning tank of 1.8 m in length. For cleansing of an oil used in the press forming process, use was made of a hydrocarbon-based solvent.

For the liquid-repellent agent used in the liquid-repellent treatment tank 9, use was made of a fluorine-based liquid-repellent agent (NOVEC™1720) manufactured by Sumitomo 3M Ltd. Further, a 2% dilute solution of the liquid-repellent agent was prepared by use of hydrofluoroether solvent (NOVEC™7300) to be used in for liquid-repellent treatment. Liquid-repellent treating time is adjustable according to the duration of immersion in the liquid-repellent treatment tank. With the present example, sufficient liquid repellent effects were obtained in 10 sec.

A laser beam with a wavelength of 532 nm was used as the laser beam of the surface-activation laser-beam irradiation unit 11. For the laser beam with the wavelength of 532 nm, use was made of the second harmonic of YVO₄ laser with the wavelength of 1064 nm. With the laser beam, an output was set to 0.3 W, a repetitive frequency to 32 kHz, and a pulse width to 31 μs. Under process conditions according to the present example, thermal effects on a terminal fitting were small, and activation was enabled while maintaining the surface shape of the terminal fitting, so that it was possible to concurrently remove the liquid-repellent treatment layer and the oxide film on the surface of phosphor bronze coated with nickel electroplating. A region of φ 0.8 mm was scanned by a galvanomirror, using a laser beam of φ 25 μm in diameter at intervals of 30 μm pitch, followed by laser irradiation, thereby having executed activation on the surface of a terminal fitting. Irradiation time of the laser beam was set to 0.048 sec, so as to match the press forming process speed in the case of the high-speed scudding press forming process speed 600 spm. In the laser irradiation, a decision on the positioning was made on the basis of the pilot hole 23 of a press formed terminal fitting, shown in FIG. 2A, as the reference.

As the noble-metal nanoparticle dispersion liquid for use in the noble-metal nanoparticle dispersion liquid coating unit 12, use was made of a gold nanoparticle electrically conductive paste (NPG-J: lot. 130717) manufactured by Harima Kasei Co., Ltd. The diameter of gold nanoparticle contained in the gold nanoparticle electrically conductive paste (a gold nanoparticle dispersion liquid) is 7 nm, and gold nanoparticle content is 57.0 wt %, while the paste has viscosity at 7.5 mPa·s, and specific gravity at 1.8 g/ml. For coating with the gold nanoparticle dispersion liquid, use was made of a high-speed dispenser (a PICO jet valve LV, a nozzle diameter 100 μm) manufactured by Nordson Co. Ltd, and the coating amount of the gold nanoparticle dispersion liquid was set to 2200 pl. The coating with the gold nanoparticle dispersion liquid was executed by deciding the positioning on the basis of the pilot hole as the reference just as is the case with the decision on the laser beam irradiation position for the activation in the front-end process. The coating time of the one point (the scope of one region serving as the electric contact of a terminal fitting) at 0.05 sec was attained by use of the high-speed discharge type dispenser.

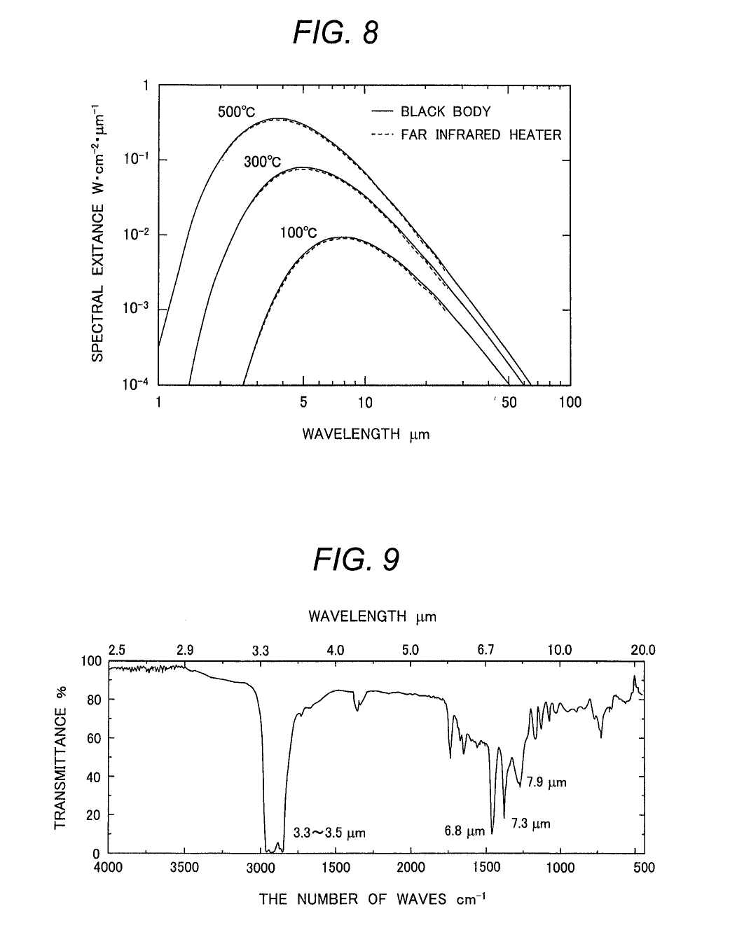

For the infrared drying furnace 13, use was made of a far infrared heater furnace having spectral emissivity at 0.95 in a far infrared region with a wavelength in a range of 3 to 25 μm, as shown in FIG. 7. FIG. 8 shows a spectral exitance curve of the far infrared heater used in the present example. In FIG. 8, there is shown a radiant energy distribution when the far infrared heater is at a temperature in a range of 100 to 500° C. Further, a solid line indicates the radiant energy distribution of a black body, a broken line indicating the radiant energy distribution of the far infrared heater. The black body is defined as an ideal body that absorbs and emits all the electromagnetic waves falling thereon (emissivity: 1). The far infrared heater used in the present example has spectral emissivity (an energy ratio in relation to the black body) at 0.95 in the region with the wavelength in the range of 3 to 25 μm, having emissivity close to that of the black body. Accordingly, the far infrared heater has a radiant energy distribution substantially similar to that of the black body in the region of the wavelength ranging from 3 to 25 μm. It is evident from FIG. 8 that the far infrared heater has high thermal radiation in a region of the wavelength of 3 μm or longer, and a radiation peak tends to move towards a shorter wavelength side following a rise in the temperature of the heater. Further, in the case of the temperature of the far infrared heater being at 500° C., the radiation peak is present in a region of the wavelength from 3 to 4 μm. Since an organic matter, such as a paint, etc., generally has a natural frequency in a region of a wavelength of 3 μm or longer, if far infrared rays are irradiated thereto, a natural frequency is excited in the vicinity of the surface of the organic matter, thereby causing a rise in temperature. Because the gold nanoparticle dispersion liquid used in the present example has an absorption wavelength in the region of a wavelength 3 μm or longer, excellent absorption of energy from the far infrared heater will take place, causing a rapid rise in temperature. For this reason, in the dry process of the gold nanoparticle dispersion liquid, which is an absorbing body having the wavelength of 3 μm or longer, if the far infrared heater having high thermal radiation in the same wavelength region as that of the gold nanoparticle dispersion liquid is used, this will enable efficient heating.

FIG. 9 shows the infrared transmission spectra of the gold nanoparticle dispersion liquid used in the present example. Measurement of the infrared transmission spectra was executed by use of an infrared spectrophoto-meter (FTS-6000) manufactured by Biorad Corp. It is evident from FIG. 9 that the gold nanoparticle dispersion liquid has an absorption peak in a range of 3.3 to 3.5 μm in wavelength, and in a range of 6.8 to 7.9 μm in wavelength. In the case of far infrared ray irradiation to the gold nanoparticle dispersion liquid, the electromagnetic waves in an absorption peak region are absorbed in the vicinity of the surface of the gold nanoparticle dispersion liquid to be converted into heat, whereas the electromagnetic waves that have penetrated into the gold nanoparticle dispersion liquid without being absorbed in the vicinity of the surface thereof, that is, the electromagnetic waves with a wavelength not higher than 3 μm and in a range of 3.5 to 7. 9 μm, are converted into heat inside the gold nanoparticle dispersion liquid. Accordingly, in the drying process using the far infrared heater, it is possible to apply heating from both the surface and the interior of the gold nanoparticle dispersion liquid, thereby enabling a drying treatment to be completed in a short time. With a heating method through heat transfer, using a hot plate, etc., if temperature is rapidly increased with the intention of completing the drying treatment in a short time, there is a possibility that bumping will occur due to abrupt heat transfer taking place from a substrate side toward the gold nanoparticle dispersion liquid, thereby causing occurrence of numerous voids on the surface of the gold nanoparticle dispersion liquid after dried. With the drying treatment using the far infrared heater according to the present example, since the solvent on the surface of the gold nanoparticle dispersion liquid, and the solvent in the interior thereof are concurrently vaporized, foaming and cracking do not occur.

With the present example, the surface temperature of the far infrared heater was set to 500° C. (the surface temperature of a terminal fitting: 200° C.) and drying for one min was executed. For the solvent of the gold nanoparticle dispersion liquid according to the present example, use was made of AF No. 7 solvent having a boiling point at 278° C., and a gold nanoparticle dispersion liquid coating portion is kept at a temperature not exceeding this boiling point because the latent heat of evaporation is taken away from the gold nanoparticle dispersion liquid coating portion. Further, since the surface of the gold nanoparticle is covered with a compound (dispersant), such as alkylamine, etc., the sintering is not started in this preliminary drying process, and the surface of the gold nanoparticle is stably maintained.

For the sintering laser beam in the sintering laser-beam irradiation unit 15, use was made of an LD laser beam with a wavelength of 915 nm. The output of the LD laser beam was set to 12 W, and the beam diameter thereof was set to φ 1.2 mm so as to be equivalent in size and shape to a noble-metal processed part of an electrical contact point. The scanning speed of the laser beam was set to 10 mm/sec {irradiation time was 0.05 sec/one point (the scope of one region serving as the electric contact of a terminal fitting)} so as to match the press forming speed in the case of the high-speed scudding press forming speed of 600 spm. Under this condition, a gold nanoparticle sintered film having excellent adherence with the terminal fitting was obtained.

### EXAMPLE 2

The present example represents the prior-press forming process method, which was executed by use of the system for manufacturing the metal-film formed product, shown in FIG. 1.

As many conditions are substantially identical to the example 1, only conditions differing from the present example are described below.

In the case of the present example, a metal strip 1 is for use in a connector (memory card shield cover), being a non-plated stock of stainless SUS 304. The metal strip is 0.15 mm in thickness, being slit to 40.0 mm in width to match the scudding stamping die 5.

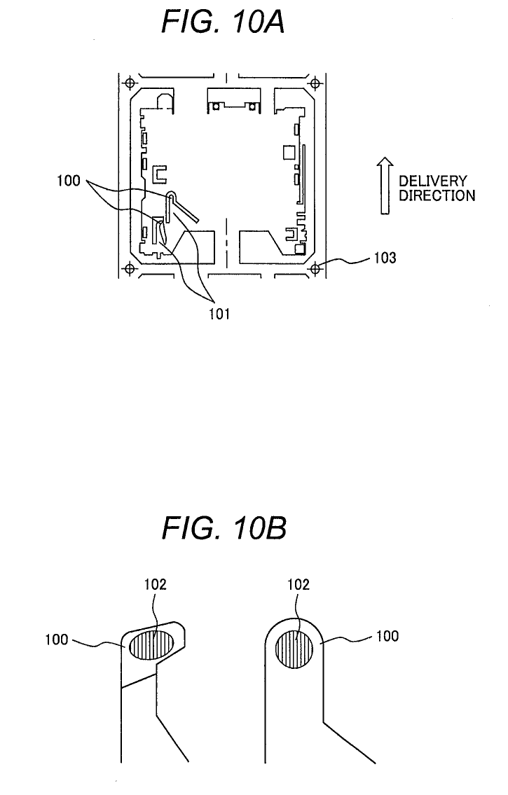

The shape of a terminal fitting for use as a press formed connector according to the present example is shown in FIGS. 10A and 10B. FIGS. 10A and 10B each show a receptacle terminal (a female terminal) fitting by way of example. The receptacle terminal fitting is composed of an electrical contact point 100, and the external connection terminal 101, and the electrical contact point 100 has a plating area 102 where the noble-metal partial plating process is applied to a portion of the electrical contact point, in contract with the male terminal.

For the laser beam of the surface-activation laser-beam irradiation unit 11, use was made of the laser beam with the wavelength of 532 nm as is the case with the example 1, and for the laser beam with the wavelength of 532 nm, use was made of the second harmonic of the YVO₄ laser with the wavelength of 1064 nm. With the laser beam, an output was set to 0.3 W, a repetitive frequency to 20 kHz, and a pulse width to 50 μs. Under process conditions according to the present invention, thermal effects on a terminal fitting were small, and activation was enabled while maintaining the surface shape of the terminal fitting, and it was possible to concurrently remove the liquid-repellent treatment layer and a passivation film on the stainless SUS 304. In laser irradiation, determination on positioning was made on the basis of a pilot hole 103 of the press formed terminal fitting shown in FIGS. 10A and 10B, used as a reference. Otherwise, the process conditions are identical to those of the example 1.

For the sintering laser beam in the sintering laser-beam irradiation unit 15, use was made of the LD laser beam with the wavelength of 915 nm, as is the case with the example 1. The output of the LD laser beam was set to 6 W, and the beam diameter thereof was set to φ 1.2 mm so as to be equivalent in size and shape to the noble-metal processed part of the electrical contact point. The heat transfer rate (16 W/m·K) of the stainless SUS 304 is small as compared with phosphor bronze (63 W/m·K), being inferior in radiation properties. Accordingly, if the output of the laser beam is increased more than necessary, thermal effects on a terminal fitting will be large, and a gold nanoparticle sintered film tends to stick to the surface of the terminal fitting, whereas if the output is conversely too small, adherence of the gold nanoparticle sintered film against the surface tends to undergo deterioration. Under this condition, it was possible to obtain a gold nanoparticle sintered film having excellent adherence with the terminal fitting.

### EXAMPLE 3

The present example represents the post-press forming process method, which was executed by use of the system for manufacturing the metal-film formed product, shown in FIG. 5.

As many conditions are substantially identical to the examples 1 and 2, only conditions differing from those embodiments are described below.

A metal strip according to the present example is a stainless SUS 304 stock before plating is applied thereto. The metal strip is 0.15 mm in thickness. First, the pilot holes 60 were formed by use of the small-type press machine 25, as shown in FIG. 6.

Conditions for the cleaning tank 7 and the liquid-repellent treatment tank 9, respectively, were identical to those in the case of the example 1.

For the laser beam of the surface-activation laser-beam irradiation unit 11, use was made of the laser beam with the wavelength of 532 nm, as with the case of the example 1, and for the laser beam with the wavelength of 532 nm, use was made of the second harmonic of YVO₄ laser with the wavelength of 1064 nm. With the laserbeam, an output, a repetitive frequency, a pulse width were set to 0.3 W, 20 kHz, and 50 μs, respectively, as with the case of the example 2. Otherwise, conditions are identical to those of the example 1.

Respective conditions for the noble-metal nanoparticle dispersion liquid coating unit 12, and the infrared drying furnace 13 are also identical to those of the example 1.

For the sintering laser beam in the sintering laser-beam irradiation unit 15, use was made of the LD laser beam with the wavelength of 915 nm, as is the case with the example 1. The output of the LD laser beam was set to 20 W, and the beam diameter thereof was set to 1.2 mm so as to be equivalent in size and shape to the noble-metal processed part of the electrical contact point. Under this condition, it was possible to obtain a gold nanoparticle sintered film having excellent adherence with the metal strip. Irradiation time of the laser was set to 0.1 sec (spot irradiation), so as to match the process speed 600 spm of a subsequent high-speed scudding press forming. With the laser sintering process according to the present example, the goldnanoparticle sintered film can be formed by successive irradiation with the laser beam, however, if thermal effects on parts other than a laser irradiation part need be reduced as much as possible, the spot irradiation is preferable.

### EXAMPLE 4

The present example represents the post-press forming process method, which was executed by use of the system for manufacturing the metal-film formed product, shown in FIG. 5.

As many conditions are substantially identical to the examples 1 to 3, only conditions differing from those examples are described below.

The metal strip according to the present example was phosphor bronze coated with nickel electroplating in a range of 0.8 to 1.5 μm in thickness. The metal strip was 0.25 mm in thickness.

For the laser beam of the surface-activation laser-beam irradiation unit 11, use was made of the laser beam with the wavelength of 532 nm as is the case with the example 1, and for the laser beam with the wavelength of 532 nm, use was made of the second harmonic of the YVO₄ laser with the wavelength of 1064 nm. With the laser beam, an output was set to 0.54 W, a repetitive frequency to 50 kHz, and a pulse width to 20 μs. Otherwise, conditions were identical to those of the example 1. Under process conditions according to the present example, thermal effects on a metal strip were small, and activation was enabled without largely changing the surface shape of the metal strip, and it was possible to concurrently remove the liquid-repellent treatment layer and the oxide film on the surface of nickel electroplating on phosphor bronze.

For the sintering laser beam in the sintering laser-beam irradiation unit 15, use was made of the LD laser beam with the wavelength of 915 nm, as is the case with the example 1. The output of the laser beam was set to 100 W, and the beam diameter thereof was set to φ 1.2 mm so as to be equivalent in size and shape to the noble-metal plating processed part of the electrical contact point. Otherwise, conditions were identical to those of the example 3. Under this condition, it was possible to obtain a gold nanoparticle sintered film having excellent adherence with the metal strip.

### EXAMPLE 5

The present example represents the post-press forming process method, which was executed by use of the system for manufacturing the metal-film formed product, shown in FIG. 5.

As many conditions are substantially identical to the examples 1 to 4, only conditions differing from those examples are described below.

The metal strip according to the present example was stainless SUS 304 coated with nickel electroplating in a range of 0.8 to 1.5 μm in thickness. The metal strip was 0.50 mm in thickness.

For the laser beam of the surface-activation laser-beam irradiation unit 11, use was made of the laser beam with the wavelength of 532 nm as is the case with the example 1, and for the laser beam with the wavelength of 532 nm, use was made of the second harmonic of the YVO₄ laser with the wavelength of 1064 nm. With the laser beam, an output was set to 0.54 W, a repetitive frequency to 40 kHz, and a pulse width to 25 μs. Otherwise, conditions were identical to those of the example 1. Under process conditions according to the present example, thermal effects on a terminal fitting were small, and activation was enabled without largely changing the surface shape of the metal strip, and it was possible to concurrently remove the liquid-repellent treatment layer and the oxide film on the surface of nickel electroplating on stainless SUS 304 metal strip.

For the sintering laser beam in the sintering laser-beam irradiation unit 15, use was made of the LD laser beam with the wavelength of 915 nm, as is the case with the example 1. The output of the laser beam was set to 60 W, and the beam diameter thereof was set to φ 1.6 mm. Under this condition, it was possible to obtain a gold nanoparticle sintered film having excellent adherence with the metal strip.

Further, it is to be pointed out that the present invention be not limited to those embodiments described in the foregoing and that variations may be included therein. For example, since those embodiments are described in detail for the sake of clarity in explaining the present invention, it is to be understood that the present invention be not necessarily limited to the embodiment provided with all the configurations as explained. Further, part of the configuration of a certain embodiment may be replaced with the configuration of another embodiment or respective configurations of other embodiments may be added to the configuration of a certain embodiment. Furthermore, addition, deletion, or replacement by use of other configuration may be made with respect to part of the configuration of each of the embodiments.

With the embodiments described as above, for example, the metal strip as a long object is transported from the let-off reel stand up to the take-up reel stand, however, the metal strip may be turned into a state of a rectangle of a specified length cut after the press forming process to thereby apply processing in the respective units for the noble-metal plating process while successively transporting the metal strip rectangle-like in shape by use of an automatic transport system.

### REFERENCE SIGN LIST

1: metal-strip, 2, 2’ :reel, 3: let-off reel stand, 5: scudding stamping die, 6: high-speedpress machine, 7, 7′: cleaning tank, 9: liquid-repellent treatment tank, 11: surface-activation laser-beam irradiation unit, 12: noble-metal nanoparticle dispersion liquid coating unit, 14: infrared drying furnace, 15: sintering laser-beam irradiation unit, 16: take-up reel stand.

1. A metal-film forming method for applying noble-metal plating to the surface of a base metal, the metal-film forming method comprising:
a surface activation process of irradiating a laser beam to the surface of the base metal, thereby activating the surface of the base metal;
a noble-metal nanoparticle dispersion liquid coating process of coating the surface of the base metal with a noble-metal nanoparticle dispersion liquid, a solvent thereof, containing noble-metal nanoparticles in as-dispersed state; and
a noble-metal nanoparticle sintering process of irradiating the laser beam to the noble-metal nanoparticle dispersion liquid coated on the surface of the base metal, thereby causing the noble-metal nanoparticles to be sintered.

2. The metal-film forming method according to claim 1, further comprising a liquid-repellent agent coating process of coating the surface of the base metal with a liquid-repellent agent prior to the surface activation process,
wherein the surface activation process, in addition to activating the surface of the base metal, is executed to decompose and remove the liquid-repellent agent coated on the surface of the base metal to thereby restrict a coating region of the noble-metal nanoparticle dispersion liquid.

3. The metal-film forming method according to claim 2, further comprising a solvent-drying process of causing part of the solvent in the noble-metal nanoparticle dispersion liquid to be evaporated, the solvent-drying process being executed after the noble-metal nanoparticle dispersion liquid coating process, and before the noble-metal nanoparticle sintering process.

4. The metal-film forming method according to claim 3, wherein the solvent-drying process is executed by use of a far infrared heater.

5. The metal-film forming method according to claim 4, wherein the far infrared heater for use in the solvent-drying process has a high radiant energy distribution in a wavelength region where radiant energy is absorbed by the noble-metal nanoparticle dispersion liquid.

6. The metal-film forming method according to claim 1, wherein the surface activation process is executed with the use of the laser beam with a wavelength in a range of 500 to 550 nm.

7. The metal-film forming method according to claim 2, wherein the surface activation process is executed with the use of the laser beam with a wavelength in a range of 500 to 550 nm.

8. The metal-film forming method according to claim 3, wherein the surface activation process is executed with the use of the laser beam with a wavelength in a range of 500 to 550 nm.

9. The metal-film forming method according to claim 4, wherein the surface activation process is executed with the use of the laser beam with a wavelength in a range of 500 to 550 nm.

10. The metal-film forming method according to claim 5, wherein the surface activation process is executed with the use of the laser beam with a wavelength in a range of 500 to 550 nm.

11. A method for manufacturing a metal-film formed product, the method comprising:
a scudding press process of executing press forming of a base metal; and
a metal-film forming process of applying noble-metal plating to the surface of the base metal,
wherein the scudding press process and the metal-film forming process are executed on the same line, and
wherein the metal-film forming process comprising:
a cleaning process of removing oil attached to the surface of the base metal;
a liquid-repellent agent coating process of coating the surface of the base metal after the cleaning process with a liquid-repellent agent;
a surface activation process of irradiating a laser beam to a noble-metal plating applied region of the base metal after the liquid-repellent agent coating process to thereby execute surface activation;
a noble-metal nanoparticle dispersion liquid coating process of noncontact-coating a region of the base metal after the surface activation process, the region being subjected to the surface activation, with a noble-metal nanoparticle dispersion liquid, a solvent thereof, containing noble-metal nanoparticles in as-dispersed state;
a solvent-drying process of causing part of the solvent in the noble-metal nanoparticle dispersion liquid coated on the base metal after the noble-metal nanoparticle dispersion liquid coating process to be evaporated by use of a far infrared heater; and
a noble-metal nanoparticle sintering process of irradiating the laser beam to the noble-metal nanoparticle dispersion liquid, part of the solvent thereof being evaporated, and the liquid being coated on the surface of the base metal after the solvent-drying process, thereby causing the noble-metal nanoparticles to be sintered.

12. The method for manufacturing the metal-film formed product according to clam 11, wherein a position identifier is provided in the basemetal, and the surface activation process, the noble-metal nanoparticle dispersion liquid coating process, and the noble-metal nanoparticle sintering process, included in the metal-film forming process, are executed, upon noncontact detection of the position identifier, such that a laser-beam irradiation region in the surface activation process, a noble-metal nanoparticle dispersion liquid coating region in the noble-metal nanoparticle dispersion liquid coating process, and a laser-beam irradiation region in the noble-metal nanoparticle sintering process are overlapped with each other.

13. The method for manufacturing the metal-film formed product according to clam 12, wherein the metal-film forming process is executed after the scudding press process, and a pilot hole for use as the position identifier is formed in the scudding press process.

14. The method for manufacturing the metal-film formed product according to clam 12, wherein the metal-film forming process is executed before the scudding press process, and a pilot hole for use as the position identifier is formed in the base metal before the metal-film forming process.

15. A system for manufacturing a metal-film formed product by executing both a scudding press process of press forming of a base metal, and a metal-film forming process of applying noble-metal plating to the surface of the base metal, on the same line, the system comprising:
a press unit configured to execute the scudding press process;
a metal-strip feeder configured to supply the base metal as a metal strip to the press unit;
a cleaning tank configured to be supplied with the metal strip delivered via the press unit and to remove oil attached to the surface of the base metal;
a liquid-repellent treatment tank configured to be supplied with the metal strip delivered via the cleaning tank and to coat the surface of the base metal with a liquid-repellent agent;
a surface-activation laser-beam irradiation unit configured to be supplied with the metal-strip delivered via the liquid-repellent treatment tank and to irradiate a laser beam for surface-activation to a region of the base metal, for noble-metal plating;
a noble-metal nanoparticle dispersion liquid coating unit configured to be supplied with the metal strip delivered via the surface-activation laser-beam irradiation unit and to noncontact-coat a surface activated region of the base metal with a noble-metal nanoparticle dispersion liquid, a solvent thereof, containing noble-metal nanoparticles in as-dispersed state;
an far infrared heater configured to be supplied with the metal strip delivered via the noble-metal nanoparticle dispersion liquid coating unit and to evaporate part of the solvent in the noble-metal nanoparticle dispersion liquid applied to the base metal;
a sintering laser-beam irradiation unit configured to be supplied with the metal-strip delivered via the far infrared heater and to irradiate a laser-beam to the noble-metal nanoparticle dispersion liquid, part of the solvent thereof having undergone evaporation, thereby causing the noble-metal nanoparticles to be sintered; and
a winding unit configured to wind up the metal-strip delivered via the sintering laser-beam irradiation unit,
wherein the surface-activation laser-beam irradiation unit, the noble-metal nanoparticle dispersion liquid coating unit, and the sintering laser-beam irradiation unit are each provided with a delivery device for transport of the metal strip and a detector configured to noncontact-detect a position identifier provided in the base metal, based on noncontact detection of the position identifier by the detector, a drive of each of the delivery devices being controlled such that a laser-beam irradiation region in the surface-activation laser-beam irradiation unit, a noble-metal nanoparticle dispersion liquid coating region in the noble-metal nanoparticle dispersion liquid coating unit, and a laser-beam irradiation region in the sintering laser-beam irradiation unit are overlapped with each other.

16. The system for manufacturing the metal-film formed product according to claim 15, wherein the surface-activation laser-beam irradiation unit and the noble-metal nanoparticle dispersion liquid coating unit are provided in the same case, and the delivery device is a delivery device shared by the surface-activation laser-beam irradiation unit and the noble-metal nanoparticle dispersion liquid coating unit.

17. A system for manufacturing a metal-film formed product by executing both a scudding press process of press forming of a base metal, and a metal-film forming process of applying noble-metal plating to the surface of the base metal, on the same line, the system comprising:
a pilot hole forming unit configured to form a pilot hole in the base metal, the pilot hole being for use as a position identifier of the base metal;
a metal-strip feeder configured to supply the base metal as a metal strip to the pilot hole forming unit:
a cleaning tank configured to be supplied with the metal strip delivered via the pilot hole forming unit and to remove oil attached to the surface of the base metal;
a liquid-repellent treatment tank configured to be supplied with the metal strip delivered via the cleaning tank and to coat the surface of the base metal with a liquid-repellent agent;
a surface-activation laser-beam irradiation unit configured to be supplied with the metal-strip delivered via the liquid-repellent treatment tank and to irradiate a laser beam for surface-activation to a region of the base metal, for noble-metal plating;
a noble-metal nanoparticle dispersion liquid coating unit configured to be supplied with the metal-strip delivered via the surface-activation laser-beam irradiation unit and to noncontact-coat a surface activated region of the base metal with a noble-metal nanoparticle dispersion liquid, a solvent thereof, containing noble-metal nanoparticles in as-dispersed state;
an far infrared heater configured to be supplied with the metal strip delivered via the noble-metal nanoparticle dispersion liquid coating unit and to evaporate part of the solvent in the noble-metal nanoparticle dispersion liquid applied to the base metal;
a sintering laser-beam irradiation unit configured to be supplied with the metal strip delivered via the far infrared heater and to irradiate a laser-beam to the noble-metal nanoparticle dispersion liquid, part of the solvent thereof being evaporated, thereby causing the noble-metal nanoparticles to be sintered;
a press unit configured to be supplied with the metal strip delivered via the sintering laser-beam irradiation unit and to execute scudding press to the base metal; and
a winding unit configured to wind up the metal strip delivered via the press unit,
wherein the surface-activation laser-beam irradiation unit, the noble-metal nanoparticle dispersion liquid coating unit, and the sintering laser-beam irradiation unit are each provided with a delivery device for transport of the metal strip and a detector configured to noncontact-detect a position identifier provided in the base metal, based on noncontact detection of the position identifier by the detector, a drive of each of the delivery devices being controlled such that a laser-beam irradiation region in the surface-activation laser-beam irradiation unit, a noble-metal nanoparticle dispersion liquid coating region in the noble-metal nanoparticle dispersion liquid coating unit, and a laser-beam irradiation region in the sintering laser-beam irradiation unit are overlapped with each other.

18. The system for manufacturing the metal-film formed product according to claim 17, wherein the surface-activation laser-beam irradiation unit and the noble-metal nanoparticle dispersion liquid coating unit are provided in the same case, and the delivery device is a delivery device shared by the surface-activation laser-beam irradiation unit and the noble-metal nanoparticle dispersion liquid coating unit.
